(19) United States
(12) Patent Application Publication
(10) Pub. No.: US 2023/0245043 A1
(43) Pub. Date: Aug. 3, 2023

(54) AUTOMATICALLY DETERMINING OFFER PRICES FOR A DRIVER ASSIGNMENT PROCESS FOR ORDER DELIVERIES

(71) Applicant: Walmart Apollo, LLC, Bentonville, AR (US)

(72) Inventors: Minghui Liu, San Bruno, CA (US); Xi Chen, McLean, VA (US); Zhenyu Wang, Dallas, TX (US); Mingang Fu, Palo Alto, CA (US)

(73) Assignee: Walmart Apollo, LLC, Bentonville, AR (US)

(21) Appl. No.: 17/589,597

(22) Filed: Jan. 31, 2022

(51) Int. Cl. G06Q 10/08; G06N 20/00

(52) U.S. Cl. CPC G06Q 10/08345; G06N 20/00

(57) ABSTRACT

A method implemented via execution of computing instructions configured to run at one or more processors and stored at one or more non-transitory computer-readable media. The method can include receiving, via a computer network, a delivery request for an order. The method further can include determining a base delivery price for the delivery request. The method also can include determining, by a desirability machine learning model, a desirability score for the base delivery price based at least in part on a source location, an order size group, a distance group, and delivery timing information for the delivery request. The method additionally can include determining an elasticity coefficient for the desirability score. Moreover, the method can include determining a delivery offer price for the delivery request based at least in part on the base delivery price, the desirability score, and the elasticity coefficient. Finally, the method can include implementing a driver assignment process for the delivery request based at least in part on the delivery offer price. Other embodiments are described.

### TECHNICAL FIELD

This disclosure relates generally to automatically determining initial offer prices for assigning delivery drivers.

### BACKGROUND

Existing delivery driver assignment techniques use predetermined functions and/or rules to determine initial offer prices based on historical data. The existing functions and/or rules are not dynamically updated to reflect the recent trend of the delivery pricing. The initial offer prices generated by these functions or rules thus may be far from acceptable to delivery drivers. As a result, existing driver assignment systems and/or methods either take a long time to adjust offer prices repeatedly until the prices become desirable to the drivers or sacrifice the potential profits for the retailer or the delivery network when the offer prices start too high. Therefore, systems and/or methods that can automatically and dynamically determine initial offer prices that meet at least an acceptable degree of desirability to the drivers are desired.

### BRIEF DESCRIPTION OF THE DRAWINGS

To facilitate further description of the embodiments, the following drawings are provided in which:

FIG. 1 illustrates a front elevation view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for automatically determining offer prices for order deliveries, according to an embodiment;

FIG. 4 illustrates a flow chart for a method for automatically determining an offer price to be used in a driver assignment process for an order delivery, according to an embodiment; and

FIG. 5 illustrates a flow chart for a method for implementing a driver assignment process, according to another embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately 0.1 second, 0.5 second, one second, two seconds, five seconds, or ten seconds.

### DESCRIPTION OF EXAMPLES OF EMBODIMENTS

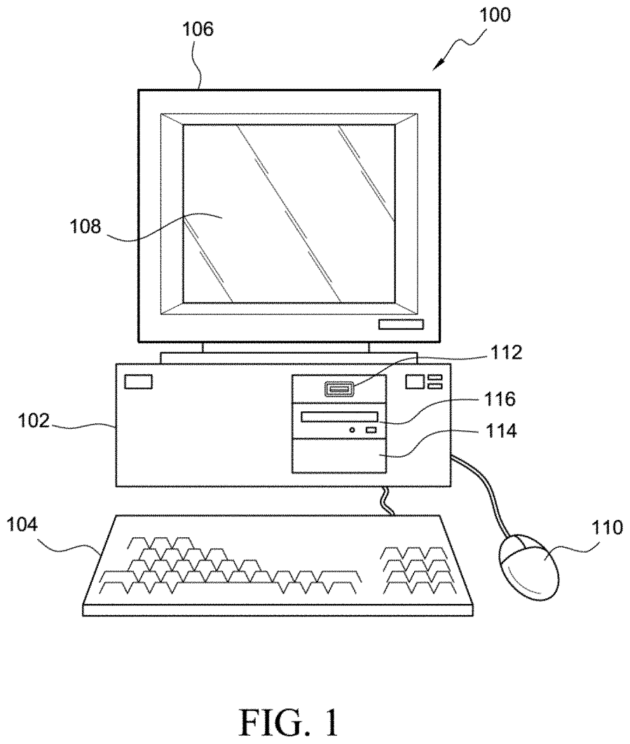

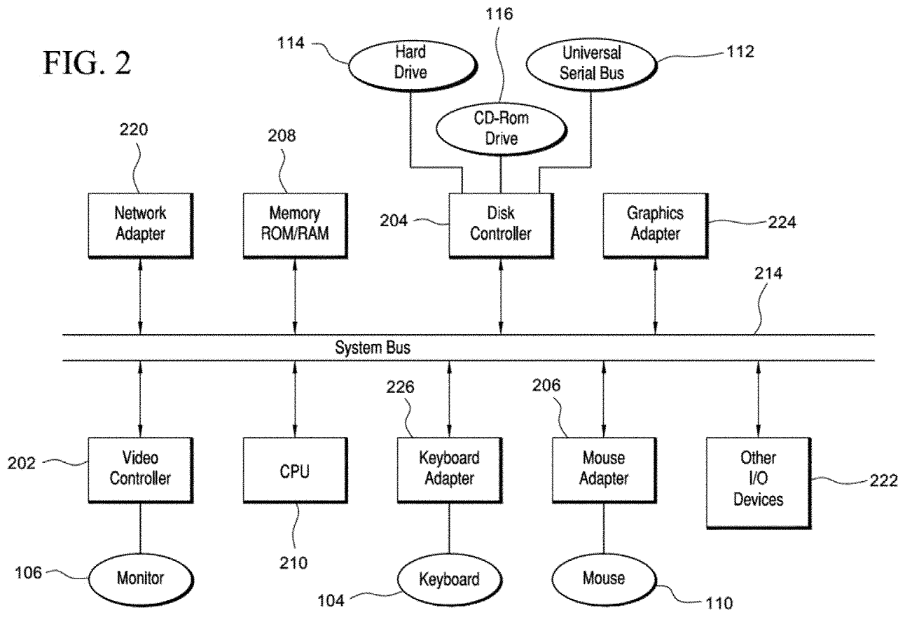

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. (Microsoft) of Redmond, Wash., United States of America, (ii) Mac® OS X by Apple Inc. (Apple) of Cupertino, Calif., United States of America, (iii) UNIX® OS, and (iv) Linux® OS. Further exemplary operating systems can comprise one of the following: (i) the iOS® operating system by Apple, (ii) the Blackberry® operating system by Research In Motion (RIM) of Waterloo, Ontario, Canada, (iii) the WebOS operating system by LG Electronics (LG) of Seoul, South Korea, (iv) the Android™ operating system developed by Google, Inc. (Google) of Mountain View, Calif., United States of America, or (v) the Windows Mobile™ operating system by Microsoft.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computing device 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

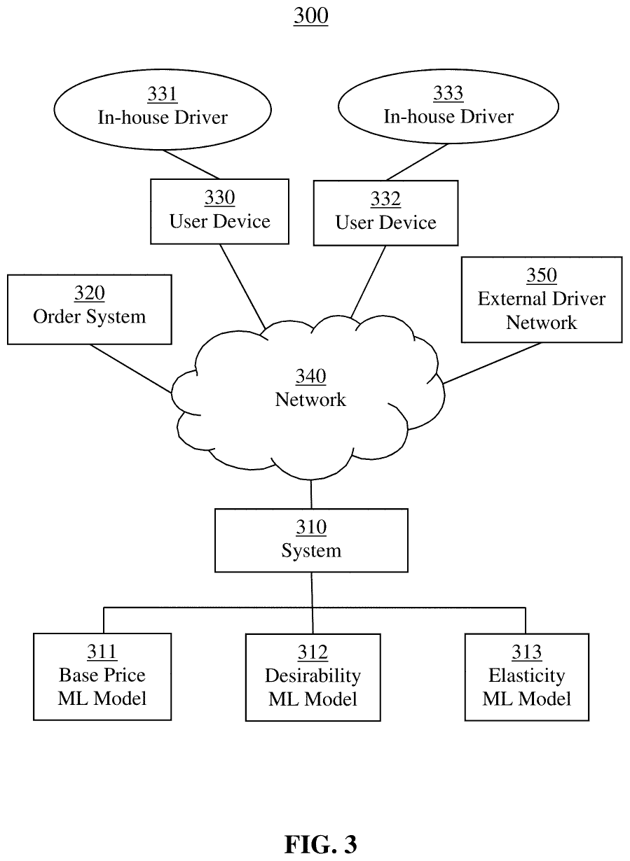

Turning ahead in the drawings, FIG. 3 illustrates a block diagram of a system 300 that can be employed for automatically determining desirable offer prices for order deliveries, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include one or more systems (e.g., system 310, order system 320, and/or external driver network 350) and one or more user devices (e.g., user devices 330 and/or 332) for various users (e.g., in-house drivers 331 and/or 333). In certain embodiments, order system 320 and/or external driver network 350 can be external systems separate from system 300. In a few embodiments, system 310 can include order system 320. System 310, order system 320, external driver network 350, and/or user devices 330 and/or 332 can each be a computer system, such as computer system 100 (FIG. 1), as described above, and can each be a single computer, a single server, or a cluster or collection of computers or servers, or a cloud of computers or servers. In another embodiment, a single computer system can host each of system 310, order system 320, external driver network 350, and/or user devices 330 and/or 332. In many embodiments, system 310 can be modules of computing instructions (e.g., software modules) stored at non-transitory computer readable media that operate on one or more processors. In other embodiments, system 310 can be implemented in hardware. In many embodiments, system 310 can comprise one or more systems, subsystems, servers, modules, or models, such as one or more machine learning (ML) models (e.g., base price ML model 311, desirability ML model 312, and/or elasticity ML model 313), implemented via software and/or hardware. Additional details regarding system 310, base price ML model 311, desirability ML model 312, elasticity ML model 313, order system 320, external driver network 350, and/or user devices 330 and/or 332 are described herein.

In some embodiments, system 310 can be in data communication, through a network 340 (e.g., a computer network, a telephone network, and/or the Internet), with order system 320, external driver network 350, and/or user devices 330 and/or 332. In some embodiments, user devices 330 and/or 332 can be used by users, such as in-house drivers 331 and/or 333, respectively. In a number of embodiments, order system 320 can comprise a front end subsystem that hosts one or more websites and/or mobile application servers. For example, the front end subsystem of order system 320 can host a web site, or provide a server that interfaces with an application (e.g., a mobile application, a web browser, or a calendar application), on consumer devices, which allow consumers to browse, search, and/or purchase items (e.g., products or produces offered for sale by a retailer), in addition to other suitable activities.

In certain embodiments, order system 320 can generate a delivery request for an order received from a consumer device and transmit, via the computer network, the telephone network, or the Internet (e.g., network 340), the delivery request to system 310 for system 310 to implement a driver assignment process to assign a delivery driver from the one or more in-house drivers (e.g., in-house drivers 331 and/or 333). In a few embodiments, when system 310 fails to assign any in-house delivery driver for the delivery request, system 310 can forward, via the computer network, the telephone network, or the Internet (e.g., network 340), the delivery request to one or more external driver networks, such as external driver network 350.

In some embodiments, an internal network (e.g., network 340) that is not open to the public can be used for communications between system 310 with order system 320, external driver network 350, and/or user devices 330 and/or 332. In these or other embodiments, the operator and/or administrator of system 310 can manage system 310, the processor(s) of system 310, and/or the memory storage unit(s) of system 310 using the input device(s) and/or display device(s) of system 310.

In certain embodiments, the user devices (e.g., user devices 330 and/or 332) can be desktop computers, laptop computers, mobile devices, and/or other endpoint devices used by one or more users (e.g., in-house drivers 331 and/or 333). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Wash., United States of America.

In many embodiments, system 310 can include one or more input devices (e.g., one or more keyboards, one or more keypads, one or more pointing devices such as a computer mouse or computer mice, one or more touchscreen displays, a microphone, etc.), and/or can comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to system 310 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of system 310. In a similar manner, the processors and/or the non-transitory computer-readable media can be local and/or remote to each other.

Meanwhile, in many embodiments, system 310 also can be configured to communicate with one or more databases. The one or more databases can include an order database that includes information for orders received from order system 320, a driver database that contains information about in-house drivers and their respective schedules, and/or a delivery request database that contains information about delivery requests handled, being handled, or to be handled, by system 310. Examples of information about a delivery request in the delivery request database can include information about a source of the delivery itinerary associated with the delivery request (e.g., a geographic area the source is located, etc.), a total size of the item(s) to be delivered, an estimated arrival time window, a type of the delivery (e.g., regular or express, or same-day delivery, next-day delivery, 3-5 business day, etc.), a destination of the delivery itinerary, an estimated distance of the delivery itinerary, contact information of the recipient, and so forth.

In some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units. Further, the one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, system 300, system 310, and/or the one or more databases can be implemented using any suitable manner of wired and/or wireless communication. Accordingly, system 300 and/or system 310 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, system 310 can receive, via network 340, a delivery request for an order. The order can be an online order of one or more products that order system 320 receives, via network 340, from a consumer device for a consumer. The delivery request for the order can be generated by order system 320 based on information of the order provided by the consumer, such as a recipient's name, a delivery address, a phone number, an estimated arrival time window, a priority of the delivery, etc. Upon receiving the delivery request, system 300 further can determine a base delivery price for the delivery request. In some embodiments, system 300 can use any suitable algorithms, functions, rules, and/or machine learning models (e.g., base price ML model 311) to determine the base delivery price. Base price ML model can be pre-trained to determine the base delivery price based on information about the delivery request, such as the geographic areas of the source (e.g., a store or a distribution center) and/or the destination for the delivery, the day and time of the estimated arrival time window, the order size, the delivery priority, a distance between the source and the destination, an estimated distance of the delivery itinerary from the source to the destination, etc.

In a number of embodiments, system 300 additionally can determine a desirability score for the base delivery price. System 300 can use any suitable algorithms, functions, rules, and/or machine learning models (e.g., desirability ML model 312) to determine the desirability score for the base delivery price. Desirability ML model 312 can be pre-trained based on information about the delivery request, such as the geographic area of the source, the order size or the order size group (e.g., small, medium, or large), the distance or the distance group (e.g., 0-10 miles, 10-20 miles, etc.), and/or the delivery timing information (e.g., the delivery priority, the day and/or start time of the estimated arrival time window, etc.) for the delivery request.

In several embodiments, after determining the desirability score for the based delivery price, system 300 further can determine an elasticity coefficient for the desirability score. System 300 can use any suitable algorithms, functions, rules, and/or machine learning models (e.g., elasticity ML model 313) to determine the elasticity coefficient. Elasticity ML model 313 can be pre-trained to determine the elasticity coefficient for the desirability score based on the desirability score and/or information about the delivery request, such as the geographic areas of the source and/or the destination for the delivery, the day and time of the estimated arrival time window (e.g., 8 am-12 pm of Monday, 1-3 pm of Thursday, 4-8 pm of a weekday, or 10 am-12 pm of weekend, etc.), the order size, the delivery priority, the distance between the source and the destination, etc.

In some embodiments, after determining the base delivery price, the desirability score, and the elasticity coefficient, system 300 further can determine a delivery offer price for the delivery request based at least in part on the base delivery price, the desirability score, and the elasticity coefficient. For example, system 300 can decrease or increase the delivery offer price, from the base delivery price, when the desirability score for the base delivery price is greater or less than a predetermined desirability target (e.g., 0.83, 0.85, 0.87, 0.90, etc.) so that after adjusting the delivery offer price, the desirability score of the delivery offer price, as adjusted, can match or at least be closer to the predetermined desirability target. In several embodiments, the predetermined desirability target can be a range or include more than one target values. For example, when the desirability score of the base delivery price is greater than an upper limit of the range of the predetermined desirability target, the delivery offer price can be decreased from the base delivery price until the desirability score of the delivery offer price reaches the upper limit. When the when the desirability score of the base delivery price is less than a lower limit of the range of the predetermined desirability target, the delivery offer price can be increased from the base delivery price until the desirability score of the delivery offer price reaches the lower limit. In many embodiments, system 300 also can include one or more constraints when determining the delivery offer price. Examples of the constraints can include that the delivery offer price must be less than a market value of a comparable delivery request, that the increase from the base delivery price cannot exceed a certain threshold (e.g., 5%, 10%, $1.00, or $2.50), and so forth.

In many embodiments, upon determining the delivery offer price, system 300 can implement a driver assignment process for the delivery request based at least in part on the delivery offer price. In some embodiments, the driver assignment process for the delivery request can include a pre-surge assignment process in which a delivery offer price is presented for one or more in-house drivers to accept, a broadcast surge assignment process in which the delivery offer price increases (with a fixed amount or an amount determined based on the initial delivery offer price), and/or an external driver assignment process in which the delivery price and the delivery driver are determined by an external delivery network (e.g., external driver network 350). The pre-surge assignment process further can include one or more processes, such as a round-robin assignment process and a broadcast assignment process, to be implemented sequentially. These exemplary driver assignment processes are described below in further detail.

Conventional systems are unable to automatically determine an offer price for a delivery request for an order that is desirable for the delivery drivers and also profitable for the requester for delivery (e.g., a retailer or a delivery network). This is because conventional systems typically lack the ability to timely and accurately predict how desirable an offer price is for an order delivery that may vary depending on the delivery geographic area, the size of items to be delivered, the day and time of the estimated arrival time windows, the trend of delivery prices associated with increased living costs and/or fuel costs or increased/decreased number of in-house drivers, etc., and adjust the offer price accordingly. Not being able to determine a desirable and profitable offer price would result in time wasted in the driver assignment process when the initial offer price is too low and has to be increased in one or more additional rounds to become acceptable and/or profits lost if the initial offer price is too high. Further, client experience would be tainted when the system cannot determine, in a timely manner, the delivery cost to charge the customer, if needed, or whether any driver would be available to deliver at the requested time window. In many embodiments, driver assignment techniques provided by system 300 and/or system 310 can advantageously address the problem by training one or more machine learning algorithms based on historical and dynamic input data and determining delivery offer prices that are profitable and more likely desirable to the drivers.

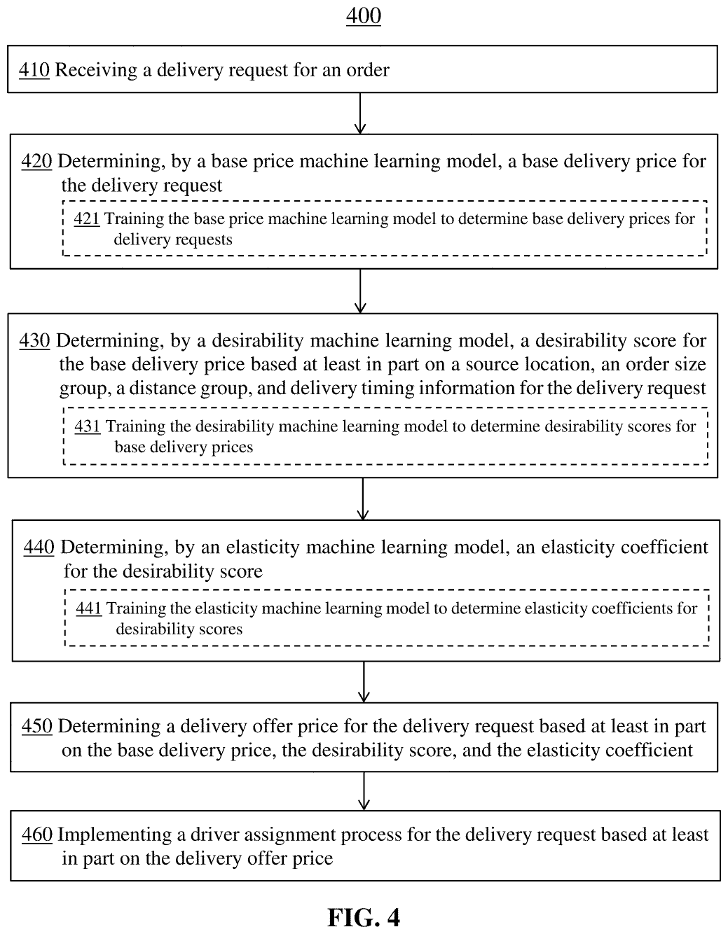

Turning ahead in the drawings, FIG. 4 illustrates a flow chart for a method 400, according to an embodiment. In many embodiments, method 400 can be implemented via execution of computing instructions on one or more processors for automatically determining an offer price for an order delivery. Method 400 is merely exemplary and is not limited to the embodiments presented herein. Method 400 can be employed in many different embodiments or examples not specifically depicted or described herein. In some embodiments, the procedures, the processes, the activities, and/or the blocks of method 400 can be performed in the order presented. In other embodiments, the procedures, the processes, the activities, and/or the blocks of method 400 can be performed in any suitable order. In still other embodiments, one or more of the procedures, the processes, the activities, and/or the blocks of method 400 can be combined or skipped.

In many embodiments, system 300 (FIG. 3) and/or system 310 (FIG. 3) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of a computer system such as system 300 (FIG. 3) and/or system 310 (FIG. 3). The processor(s) can be similar or identical to the processor(s) described above with respect to computer system 100 (FIG. 1).

In many embodiments, method 400 can be performed by a computer server, such as system 300 (FIG. 3) and/or system 310 (FIG. 3), to receive a delivery request for an order (block 410). The delivery request can be generated by and/or received from a remote server or computer system (e.g., order system 320 (FIG. 3)) via a network (e.g., network 340 (FIG. 3)). The delivery request further can be associated with one or more items in the order. The delivery request can include various information about the order and the delivery requested provided by a customer or the remote server or computer system. For instance, the delivery request can include information about the store or distribution center for fulfilling the order, the destination of the delivery, the size of the order (or the one or more items of the order to be delivered), the day and time of the estimated time of arrival, the priority of the delivery, the customer's delivery instruction, etc.

In some embodiments, method 400 further can include determining a base delivery price for the delivery request. The base delivery price can be a predetermined price or determined based on any suitable functions (e.g., an average or median of prices for prior similar delivery requests in similar geographic areas, of similar order sizes, delivered in similar time windows, etc.), rules, and/or machine learning algorithms. In a number of embodiments, method 400 can use a base price machine learning model (e.g., base price ML model 311 (FIG. 3)), pre-trained in block 421, to determine the base delivery price (block 420). The base price machine learning model used in block 420 and/or trained in block 421 can include any suitable machine learning algorithms, such as linear regression.

In many embodiments, training the base price machine learning model (e.g., base price ML model 311 (FIG. 3)) in block 421 can comprise estimating internal parameters and/or using labeled training data, otherwise known as a training dataset. In some embodiments, the training dataset for the base price machine learning model can be associated with all or a part of prior delivery requests described above in connection with block 410. For instance, the one or more prior delivery requests used in the training dataset for training the base price machine learning model in block 421 can be limited to those previously accepted by in-house drivers in a pre-surge assignment process (e.g., a round-robin assignment process or a broadcast assignment process). In a number of embodiments, the one or more prior delivery requests used in the training dataset for block 421 further can be limited to recent delivery requests (e.g., delivery requests received or processed in the past week, 2 weeks, 4 weeks, 30 days, 60 days, etc.).

In some embodiments, the training dataset for the base price machine learning model further can include historical input data and historical output data associated with the one or more prior delivery requests accepted in a pre-surge assignment process. The historical input data of the training dataset can include feature vectors for the one or more prior delivery requests, and the historical output data of the training dataset can include a respective delivery price for each of the one or more prior delivery requests. In some embodiments, the feature vectors of the historical input data of the training dataset can be associated with certain information of the one or more prior delivery requests. For instance, the information can include a respective prior source location (e.g., a zone, zip code, district, or city of the store for fulfilling the respective order), a respective prior order size group (e.g., small, medium, or large, etc.), a respective prior delivery distance, and respective prior delivery timing information (e.g., 8-9 am or 10-12 am of a weekday, or 1-5 pm of a weekend, etc.; regular or express delivery, etc.; and/or same-day or 2-day delivery, etc.) for each of the one or more prior delivery requests. In this way, the base price machine learning model, as trained in block 421, can be configured to determine the base delivery price for the delivery request based at least in part on the information of the delivery request, such as a source location, an order size group, a delivery distance, and delivery timing information for this delivery request.

In a number of embodiments, method 400 additionally can include determining a desirability score for the base delivery price determined in block 420. The desirability score can be determined based at least in part on a source location, an order size group, a distance group, and delivery timing information for the delivery request. The desirability score further can be determined based on any suitable functions, rules, and/or machine learning algorithms. In a number of embodiments, method 400 further can use a pre-trained desirability machine learning model (e.g., desirability ML model 312 (FIG. 3)) to determine the desirability score for the base delivery price (block 430). In several embodiments, method 400 also can include, prior to determining the desirability score for the base delivery price, training the desirability machine learning model in block 431, based on a training dataset. The desirability machine learning model (e.g., desirability ML model 312 (FIG. 3)) used in block 430 and/or trained in block 431 can include any suitable machine learning algorithms, such as logistic regression, random forest, and/or gradient boosting, etc.

In many embodiments, the training dataset for the desirability machine learning model (e.g., desirability ML model 312 (FIG. 3)) can include historical input data and historical output associated with one or more prior delivery requests described above in connection with block 410. In some embodiments, the training dataset for the desirability learning model can be associated with all or a part of prior delivery requests described above in connection with block 410. For example, the one or more prior delivery requests used in the training dataset for training the desirability machine learning model in block 431 can be limited to recent delivery requests (e.g., delivery requests received or processed by a system (e.g., system 300 (FIG. 3) or 310 (FIG. 3)) in the past 1 week, 2 weeks, 6 weeks, 1 month, 2 months, etc.).

In a number of embodiments, the historical input data of the training dataset for the desirability machine learning model (e.g., desirability ML model 312 (FIG. 3)) can include feature vectors for the one or more prior delivery requests, such as a respective base delivery price, a respective source location (e.g., the zone, zip code, or city of the store or the distribution center), a respective order size group (e.g., small, medium, large, etc.), a respective distance group (e.g., <5 miles, 5-10 miles, 10-20 miles, etc.), and/or respective delivery timing information (e.g., the start time of the estimated arrival time window or day and time of the estimated arrival time window; regular or express delivery; and/or same-day delivery, next-day delivery, etc.) for each of the one or more prior delivery requests. The historical output data of the training dataset can include a respective desirability indication of whether or not each of the one or more prior delivery requests was accepted in a pre-surge assignment process, reflecting whether a respective base price for the each of the one or more prior delivery requests was desirable to in-house drivers. As such, the desirability learning model, as trained in block 431, can be configured to determine the desirability score for the base delivery price for the delivery request based on the base delivery price and certain information of the delivery request, such as a source location, an order size group, a distance group, and/or delivery timing information for the delivery request for the delivery request.

In a number of embodiments, method 400 further can include determining an elasticity coefficient for the desirability score determined in block 430. The elasticity coefficient can be determined based on any suitable functions, rules, and/or machine learning algorithms. In some embodiments, method 400 can use a pre-trained elasticity machine learning model (e.g., elasticity ML model 313 (FIG. 3)) to determine the elasticity coefficient for the desirability score (block 440). In many embodiments, method 400 can include training the elasticity machine learning model in block 441 with a training dataset. The elasticity machine learning model used in block 440 and/or trained in block 441 can include any suitable machine learning algorithms, such as linear regression.

In many embodiments, the training dataset for training the elasticity machine learning model (e.g., elasticity ML model 313 (FIG. 3)) in block 441 can be associated with all or a part of one or more prior delivery requests described above in connection with block 410. In some embodiments, the one or more prior delivery requests used in the training dataset for training the elasticity machine learning model in block 441 can be limited to those previously accepted by in-house drivers in a pre-surge assignment process (e.g., a round-robin assignment process or a broadcast assignment process) and/or a broadcast surge assignment process. In a number of embodiments, the one or more prior delivery requests used in the training dataset further can be limited to recent delivery requests (e.g., delivery requests received in the past week, 2 weeks, 4 weeks, 30 days, 60 days, etc.).

In some embodiments, the training dataset additionally can include historical input data and historical output data associated with the one or more prior delivery requests accepted by in-house drivers. The historical input data of the training dataset can include feature vectors for the one or more prior delivery requests accepted by in-house drivers, and the historical output data of the training dataset can include a respective accepted delivery price for each of the one or more prior delivery requests. In some embodiments, the feature vectors of the historical input data of the training dataset can be associated with certain information of the one or more prior delivery requests. For instance, the information can include a respective base delivery price, a respective desirability score, a respective prior source location (e.g., the predetermined zone, zip code, district, or city of the store for fulfilling the respective order), a respective prior order size group (e.g., small, medium, or large, etc.), a respective prior delivery distance, and respective prior delivery timing information (e.g., a weekday or a weekend; 8-9 am, 10-12 am, 1-5 pm, 8-10 pm, etc.; regular or express delivery; and/or same-day or next-day delivery, etc.) for each of the one or more prior delivery requests. In this way, the elasticity machine learning model, as trained in block 441, can be configured to determine the elasticity coefficient for the desirability score determined in block 430 based on the desirability score and the information of the delivery request, such as a source location, an order size group, a delivery distance, and/or delivery timing information for the delivery request.

In many embodiments, method 400 further can include a block 450 for determining a delivery offer price for the delivery request based at least in part on: (a) the base delivery price determined in block 420, (b) the desirability score of the base delivery price determined in block 430, and (c) the elasticity coefficient determined in block 440. Block 450 can determine the delivery offer price based on any suitable functions configured to make the desirability score of the delivery offer price equal or close to a predetermined desirability target (e.g., 0.75, 0.80, 0.85, 0.90, etc.) or a range (e.g., 0.80-0.88, 0.83-0.85, 0.80-0.90, etc.). In certain embodiments, the functions used in block 450 can be linear or non-linear.

In some embodiments, block 450 can determine the delivery offer price by:

P_{offer}=P_{base}+C_{elasticity}*(D_{base}−D_{target}),

wherein:
P_{offer}: a delivery offer price for a delivery request;
P_{base}: a base delivery price for the delivery request;
D_{base}: a desirability score of the base delivery price, P_{base};
D_{target}: a predetermined desirability target; and
C_{elasticity}: an elasticity coefficient for the desirability score, D_{base}.

In similar or different embodiments, the increase rate and decrease rate in the function for adjusting the delivery offer price based on the base delivery price can be different. In some embodiments, the desirability targets in the function for decreasing or increasing the delivery offer price also can be different. For example, block 450 can determine the delivery offer price by:

$${D}_{target \_ increase} = min ( {D}_{t a r g e t} , {D}_{a v g} ) ;$$

$$λ = \frac{\begin{matrix}( 1 + {PCT}_{increase} ) * {Σ}_{i ∈ DS} {P}_{a c c e p t e d} ( i ) - \\ {Σ}_{j ∈ {DS}_{d e c r e a s e}} {P}_{a c c e p ted} ( j ) - {Σ}_{k ∈ {DS}_{increase}} {P}_{b a s e} ( k )\end{matrix}}{{Σ}_{k ∈ {DS}_{increase}} ( {P}_{a c c e p t e d} ( k ) - {P}_{b a s e} ( k ) )} ;$$

$$If {D}_{b a s e} > {D}_{t a r g e t} , then$$

$${P}_{offer} = {P}_{base} + {C}_{elasticity} * ( {D}_{b a s e} — {D}_{target} ) ; and$$

$$If {D}_{b a s e} < {D}_{target \_ increase} , then$$

$${P}_{offer} = {P}_{b a s e} - λ * {C}_{{elasticity}^{*}} ( {D}_{b a s e} - {D}_{target \_ increase} ) ,$$

wherein:
P_{offer}: a delivery offer price for a current delivery request;
P_{base}: a base delivery price for the current delivery request;
D_{base}: a desirability score of the base delivery price, P_{base};
D_{target}: a predetermined upper limit of a desirability target;
D_{arg}: an average desirability score for respective base prices of prior delivery requests accepted at a pre-surge assignment process;
D_{target_increase}: a lower limit of the desirability target;
C_{elasticity}: an elasticity coefficient for the desirability score, D_{base};
λ: a market-level adjustment coefficient;
DS: a dataset comprising the prior delivery requests accepted at the pre-surge assignment process;
DS_{decrease}: a dataset comprising one or more prior price-decreased delivery requests of the prior delivery requests in DS;
DS_{increase}: a dataset comprising one or more prior price-increased delivery requests of the prior delivery requests in DS;
PCT_{increase}: a percentage of DS_{increase} to DS;
P_{accepted}(i) or P_{accepted}(j) or P_{accepted}(k): a respective delivery offer price for a prior delivery request, i or j or k, in DS, DS_{decrease}, or DS_{increase}, respectively;
P_{base}(k): a respective base price for a prior delivery request, k, in DS_{increase}; and
P_{base}(k): a base delivery price for a delivery request, k, in DS_{increase}.

In certain embodiments, block 450 further can determine the delivery offer price based on one or more predetermined constraints, e.g., a predetermined offer price floor and/or a predetermined offer price cap for the delivery offer price, a predetermined adjustment cap for any increase from the base delivery price, etc.

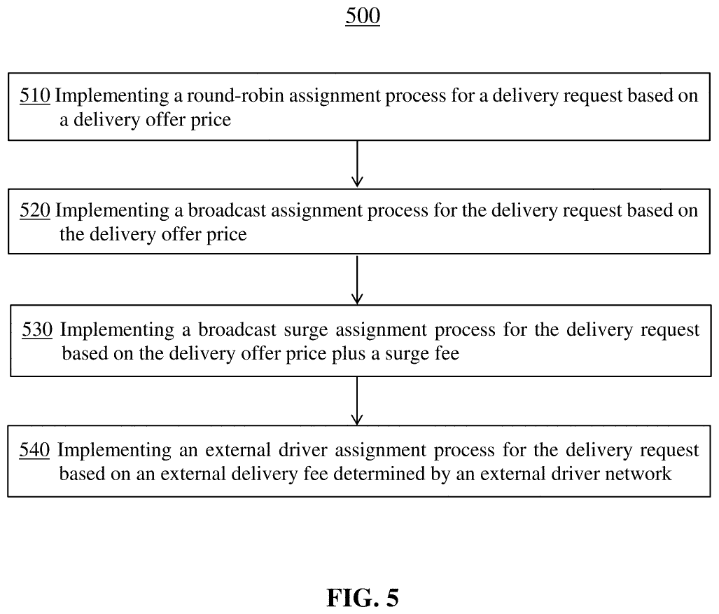

In many embodiments, method 400 further can include a block 460 for implementing a driver assignment process for the delivery request based at least in part on the delivery offer price. The driver assignment process can include one or more stages. In some embodiments, block 460 can implement the driver assignment process by: (a) implementing a pre-surge assignment process for the delivery request; (b) after implementing the pre-surge assignment process, implementing a broadcast surge assignment process for the delivery request; and (c) after implementing the broadcast surge assignment process, implementing an external driver assignment process for the delivery request. Whenever the delivery request is accepted, either by an in-house driver or an external delivery network driver, the driver assignment process is completed, and there is no need to proceed with the unfinished portion, if any. If after the entire driver assignment process is implemented, the delivery request is still not accepted by any driver, in-house or external, then block 460 can report the failure to the requester of the delivery request (e.g., order system 320 (FIG. 3)), and the requester can handle the issue accordingly (e.g., cancelling the order, proposing a modified delivery request with loosened requirements, etc.). In a few embodiments, the pre-surge assignment process further can include one or more sub-processes, such as a round-robin assignment process, a broadcast assignment process, etc. In some embodiments, block 460 can be at least partially implemented as shown in method 500 (FIG. 5, described below).

In various embodiments, any machine learning model provided above for method 400 (e.g., the base price machine learning model in block 421, the desirability machine learning model in block 431, and/or the elasticity machine learning model in block 441) can be pre-trained, or re-trained, based on a corresponding training dataset. In some embodiments, a machine learning model used in method 400 can also consider both historical and dynamic input from the system performing method 400 (e.g., system 300 (FIG. 3) or 310 (FIG. 3)). In this way, the machine learning model can be trained iteratively as data from the system is added to the corresponding training dataset. In many embodiments, the machine learning model can be iteratively trained in real time as data is added to the corresponding training dataset.

In some embodiments, the machine learning model for method 400 (e.g., the base price machine learning model in block 421, the desirability machine learning model in block 431, and/or the elasticity machine learning model in block 441) can be trained, at least in part, on a single store's delivery requests or the single store's delivery requests can be weighted in a training dataset. In this way, the machine learning model can be tailored to a single store. In several embodiments, due to a large amount of data needed to create and maintain the training dataset, the machine learning model can use extensive data inputs to determine base delivery prices, desirability scores of the base delivery prices, and/or the elasticity of the desirability scores, etc. Due to these extensive data inputs, in many embodiments, creating, training, and/or using a machine learning model configured to determine base prices, desirability of the base prices, and/or the elasticity of the desirability scores cannot practically be performed in a mind of a human being.

Moreover, in a number of embodiments, after the delivery request has been accepted and/or completed by an in-house driver, method 400 further can include determining a final delivery price for the in-house driver based at least in part on one or more predetermined adjustment conditions. Examples of the one or more predetermined adjustment conditions can include a pick-up fee if an order is cancelled after an in-house driver shows up, a wait-time fee (e.g., $0.10/minute, $0.25/minute, etc.) if the in-house driver has to wait before the order is ready for pick up, a return fee if the in-house driver is required to return to the store or distribution center, etc.

Turning ahead in the drawings, FIG. 5 illustrates a flow chart for a method 500, according to an embodiment. In many embodiments, method 500 can be implemented via execution of computing instructions on one or more processors, and the computing instructions can be stored at one or more non-transitory computer-readable media and, when executed on the one or more processors, perform automatically determining a delivery offer price for a delivery request. Method 500 is merely exemplary and is not limited to the embodiments presented herein. Method 500 can be employed in many different embodiments or examples not specifically depicted or described herein. In some embodiments, the procedures, the processes, the activities, and/or the blocks of method 500 can be performed in the order presented. In other embodiments, the procedures, the processes, the activities, and/or the blocks of method 500 can be performed in any suitable order. In still other embodiments, one or more of the procedures, the processes, the activities, and/or the blocks of method 500 can be combined or skipped. In a number of embodiments, some or all of the procedures, the processes, the activities, and/or the blocks of method 500 can be similar or identical to some or all of the procedures, the processes, and/or the activities of block 460 of method 400 (FIG. 4).

In many embodiments, system 300 (FIG. 3) and/or system 310 (FIG. 3) can be suitable to perform method 500 and/or one or more of the activities of method 500. In these or other embodiments, one or more of the activities of method 500 can be implemented as one or more computing instructions configured to run at one or more processors and configured to be stored at one or more non-transitory computer readable media. Such non-transitory computer readable media can be part of a computer system such as system 300 (FIG. 3) and/or system 310 (FIG. 3). The processor(s) can be similar or identical to the processor(s) described above with respect to computer system 100 (FIG. 1).

Referring to FIG. 5, method 500 can be performed by a computer server, such as system 300 (FIG. 3) and/or system 310 (FIG. 3), to implement a driver assignment process for a delivery request based on a delivery offer price that can be determined in block 450 (FIG. 4). In many embodiments, method 500 can include implementing a round-robin assignment process for the delivery request based on the delivery offer price (block 510). In the round-robin assignment process in block 510, the delivery request and the delivery offer price, together as an offer, can be transmitted, via a computer network, a telephone network, or the Internet (e.g., network 340 (FIG. 3)), to each of one or more in-house drivers (e.g., in-house drivers 331 (FIG. 3) and/or 333 (FIG. 3)) in turn. When a driver of the one or more in-house drivers receives, via a computer network, a telephone network, or the Internet (e.g., network 340 (FIG. 3)), the offer displayed on a user interface of the user device (e.g., user devices 330 (FIG. 3) and/or 332 (FIG. 3)) for the driver, the driver can be given a predetermined period of time (e.g., 5 minutes, 10 minutes, etc.) to accept or reject the offer, or the offer can expire. Once the offer to the driver is rejected or expires, the offer is transmitted to the next driver of the one or more in-house drivers in a predetermined sequence, until each of the one or more in-house drivers has received but not timely accepted the offer, and then the process in block 510 can be deemed to have failed. In some embodiments, the first driver of the one or more in-house drivers to start the round-robin assignment process for a different delivery request can be different so that the process is fair.

In a number of embodiments, method 500 additionally can include implementing a broadcast assignment process for the delivery request based on the delivery offer price (block 520). Block 520 can implement the broadcast assignment process, after block 510 fails to assign any in-house driver, by broadcasting, via a computer network, a telephone network, or the Internet (e.g., network 340 (FIG. 3)), the delivery request and the delivery offer price, together as an offer, to each of the one or more in-house drivers (e.g., in-house drivers 331 (FIG. 3) and/or 333 (FIG. 3)) simultaneously, or almost simultaneously. When a driver of the one or more in-house drivers receives, via a computer network, a telephone network, or the Internet (e.g., network 340 (FIG. 3)), the offer displayed on a user interface of the user device (e.g., user device 330 (FIG. 3) and/or 331 (FIG. 3)) for the driver, the drive can accept or reject the offer within a predetermined broadcast time limit. If at least one of the one or more in-house drivers accepts the offer within the predetermined broadcast time limit, the delivery request can be assigned to the driver who accepts the offer first in time. However, if none of the one or more in-house drivers accepts within the predetermined broadcast time limit, the broadcast assignment process in block 520 can be deemed to have failed.

In some embodiments, method 500 further can include implementing a broadcast surge assignment process for the delivery request based on the delivery offer price plus a surge fee (block 530). Block 530 can implement the broadcast surge assignment process, after block 520 fails to assign any in-house driver, by determining the surge fee and broadcasting, via a computer network, a telephone network, or the Internet (e.g., network 340 (FIG. 3)), the delivery request and the delivery offer price plus the surge fee, together as an offer, to each of the one or more in-house drivers simultaneously, or almost simultaneously. The surge fee for the delivery request can be a predetermined fixed fee (e.g., $2.50, $5.00, etc.), a predetermined percentage of the delivery offer price (e.g., 10%, 15%, 20%, etc.), or determined by block 530 using any suitable rules, functions, and/or pre-trained machine learning algorithms (e.g., linear regression). In some embodiments, the sum of the delivery offer price and the surge fee can be subject to one or more predetermined constraints, such as a price cap determined based on a market value, etc. In many embodiments, broadcasting the offer in block 530 can be identical or similar to the broadcast assignment process in block 520. If at least one of the one or more in-house drivers accepts the offer within a predetermined broadcast surge time limit (e.g., 10 minutes, 15 minutes, 30 minutes, etc.), the delivery request can be assigned to the driver who accepts the offer first in time. However, if none of the one or more in-house drivers accepts within the predetermined broadcast surge time limit, the broadcast surge assignment process in block 530 can be deemed to have failed.

In several embodiments, method 500 also can include implementing an external driver assignment process for the delivery request based on an external delivery fee determined by an external driver network (e.g., external driver network 350 (FIG. 3)) (block 540). Block 540 can implement the external driver assignment process by transmitting, via a computer network, a telephone network, or the Internet (e.g., network 340 (FIG. 3)), the delivery request to the external driver network. Block 540 can be notified that the external driver network has successfully assigned an external driver for the delivery request based on the rules and/or the agreed-upon fee schedule of the external driver network, or that the external driver network fails to assign any external drivers as well.

Various embodiments can include a system for determining a delivery offer price to be used in a driver assignment process for a delivery request. The system can include one or more processors and one or more non-transitory computer-readable media storing computing instructions that, when executed on the one or more processors, cause the one or more processors to perform various acts.

In a number of embodiments, the acts can include receiving, via a computer network, a delivery request for an order. The delivery request for the order can be received from a remote computer system (e.g., computer system 100 (FIG. 1) or order system 320 (FIG. 3)). In a number embodiments, the acts further can include determining a base delivery price for the delivery request. The based delivery price can be determined by one or more predetermined functions and/or machine learning algorithms, such as linear regression.

In many embodiments, the acts further can include determining, by a desirability machine learning model, a desirability score for the base delivery price based at least in part on a source location, an order size group, a distance group, and delivery timing information for the delivery request. The desirability machine learning model can include any suitable machine learning algorithms, such as logistic regression, random forest, and/or gradient boosting.

In some embodiments, the acts additionally can include determining an elasticity coefficient for the desirability score. The elasticity coefficient can be determined by one or more predefined functions and/or machine learning algorithms, such as linear regression.

In a number of embodiments, the acts also can include determining a delivery offer price for the delivery request based at least in part on the base delivery price, the desirability score, and the elasticity coefficient. The delivery offer price can be determined by a predetermined function of the base delivery price, the desirability score, and the elasticity coefficient. The predetermined function can be linear or non-linear. In some embodiments, the delivery offer price further can be determined based on one or more constraints, such as a floor/cap price.

In several embodiments, the acts further can include implementing a driver assignment process for the delivery request based at least in part on the delivery offer price. The driver assignment process further can include one or more stages or processes. In some embodiments, the driver assignment process can be used to assign in-house drivers. In similar or different embodiments, the driver assignment process can be used to assign in-house drivers and external drivers. The delivery offer price can be increased later in the driver assignment process if no driver would accept the delivery request with the delivery offer price in the earlier stages. The increase in the delivery offer price also can be subject to one or more constraints, such as an increase limit, a floor/cap price, etc.

Further, various embodiments can include a method being implemented via execution of computing instructions configured to run at one or more processors and stored at one or more non-transitory computer-readable media. The method can comprise receiving, via a computer network, a delivery request for an order. In some embodiments, the method further can include determining a base delivery price for the delivery request. The method also can include determining, by a desirability machine learning model, a desirability score for the base delivery price based at least in part on a source location, an order size group, a distance group, and delivery timing information for the delivery request. Additionally, the method can include determining an elasticity coefficient for the desirability score. Moreover, the method can include determining a delivery offer price for the delivery request based at least in part on the base delivery price, the desirability score, and the elasticity coefficient. Once the delivery offer price is known, the method further can include implementing a driver assignment process for the delivery request based at least in part on the delivery offer price.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although automatically determining a delivery offer price to be used in a driver assignment process for a delivery request has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-5 may be modified, and that the foregoing discussion of certain of these embodiments does not necessarily represent a complete description of all possible embodiments. Different functions and/or machine learning algorithms may be used to determine the base delivery price, desirability score, elasticity coefficient, and/or delivery offer price. Various training datasets can be used for training the one or more machine learning models described herein.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions that, when executed on the one or more processors, cause the one or more processors to perform:
receiving, via a computer network, a delivery request for an order;
determining a base delivery price for the delivery request;
determining, by a desirability machine learning model, a desirability score for the base delivery price based at least in part on a source location, an order size group, a distance group, and delivery timing information for the delivery request;
determining an elasticity coefficient for the desirability score;
determining a delivery offer price for the delivery request based at least in part on the base delivery price, the desirability score, and the elasticity coefficient; and
implementing a driver assignment process for the delivery request based at least in part on the delivery offer price.

2. The system in claim 1, wherein:
the delivery offer price, as determined, is lower than the base delivery price when the desirability score is greater than a predetermined target desirability; and
the delivery offer price, as determined, is greater than the base delivery price when the desirability score is lower than the predetermined target desirability.

3. The system in claim 1, wherein:
determining the base delivery price for the delivery request further comprises determining, by a base price machine learning model, the base delivery price for the delivery request; and
one or more of:
(a) the base price machine learning model is pre-trained to determine the base delivery price for the delivery request based on:
first historical input feature vectors for one or more prior accepted delivery requests; and
first historical output data comprising a respective base price for each of the one or more prior accepted delivery requests; and
each of the first historical input feature vectors is associated with a respective historical dataset comprising a respective prior source location, a respective prior order size group, a respective prior delivery distance, and respective prior delivery timing information for each of the one or more prior accepted delivery requests; or
(b) the desirability machine learning model is pre-trained to determine the desirability score for the base delivery price based on:
second historical input feature vectors for one or more prior delivery requests; and
second historical output data comprising a respective desirability indication for each of the one or more prior delivery requests; and
each of the second historical input feature vectors is associated with a respective historical dataset comprising a respective prior source location, a respective prior order size group, a respective prior distance group, and respective prior delivery timing information for each of the one or more prior delivery requests.

4. The system in claim 3, wherein:
the driver assignment process for the delivery request further comprises:
a pre-surge assignment process; and
a broadcast surge assignment process; and
each of the one or more prior accepted delivery requests for training the base price machine learning model is accepted in the pre-surge assignment process.

5. The system in claim 1, wherein:
determining the elasticity coefficient for the desirability score further comprises determining, by an elasticity machine learning model, the elasticity coefficient for the desirability score;
the elasticity machine learning model is pre-trained to determine the elasticity coefficient for the desirability score based on:
third historical input feature vectors for one or more prior accepted delivery requests; and
third historical output data comprising a respective prior accepted price for each of the one or more prior accepted delivery requests; and
each of the third historical input feature vectors is associated with a respective historical dataset comprising a respective prior desirability score, a respective prior source location, a respective prior order size group, a respective prior delivery distance, and respective prior delivery timing information for each of the one or more prior accepted delivery requests.

6. The system in claim 5, wherein:
the driver assignment process for the delivery request further comprises:
a pre-surge assignment process; and
a broadcast surge assignment process; and
each of the one or more prior accepted delivery requests for training the elasticity machine learning model is accepted in the pre-surge assignment process or the broadcast surge assignment process.

7. The system in claim 1, wherein:
the driver assignment process for the delivery request further comprises:
a pre-surge assignment process; and
a broadcast surge assignment process.

8. The system in claim 7, wherein:
the desirability machine learning model is pre-trained based on a training dataset associated with one or more prior delivery requests; and
the training dataset further comprises a respective desirability indication of whether each of the one or more prior delivery requests is accepted at the pre-surge assignment process.

9. The system in claim 7, wherein:
the driver assignment process further comprises an external driver assignment process; and
implementing the driver assignment process for the delivery request further comprises:
implementing the pre-surge assignment process for the delivery request;
after implementing the pre-surge assignment process, implementing the broadcast surge assignment process; and
after implementing the broadcast surge assignment process, implementing the external driver assignment process.

10. The system in claim 9, wherein:
implementing the pre-surge assignment process for the delivery request further comprises:
implementing a round-robin assignment process; and
after implementing the round-robin assignment process, implementing a broadcast assignment process until a predetermined broadcast time period passes before the delivery request is accepted.

11. A method being implemented via execution of computing instructions configured to run at one or more processors and stored at one or more non-transitory computer-readable media, the method comprising:
receiving, via a computer network, a delivery request for an order;
determining a base delivery price for the delivery request;
determining, by a desirability machine learning model, a desirability score for the base delivery price based at least in part on a source location, an order size group, a distance group, and delivery timing information for the delivery request;
determining an elasticity coefficient for the desirability score;
determining a delivery offer price for the delivery request based at least in part on the base delivery price, the desirability score, and the elasticity coefficient; and
implementing a driver assignment process for the delivery request based at least in part on the delivery offer price.

12. The method in claim 11, wherein:
the delivery offer price, as determined, is lower than the base delivery price when the desirability score is greater than a predetermined target desirability; and
the delivery offer price, as determined, is greater than the base delivery price when the desirability score is lower than the predetermined target desirability.

13. The method in claim 11, wherein:
determining the base delivery price for the delivery request further comprises determining, by a base price machine learning model, the base delivery price for the delivery request; and
one or more of:
(a) the base price machine learning model is pre-trained to determine the base delivery price for the delivery request based on:
first historical input feature vectors for one or more prior accepted delivery requests; and
first historical output data comprising a respective base price for each of the one or more prior accepted delivery requests; and
each of the first historical input feature vectors is associated with a respective historical dataset comprising a respective prior source location, a respective prior order size group, a respective prior delivery distance, and respective prior delivery timing information for each of the one or more prior accepted delivery requests; or
(b) the desirability machine learning model is pre-trained to determine the desirability score for the base delivery price based on:
second historical input feature vectors for one or more prior delivery requests; and
second historical output data comprising a respective desirability indication for each of the one or more prior delivery requests; and
each of the second historical input feature vectors is associated with a respective historical dataset comprising a respective prior source location, a respective prior order size group, a respective prior distance group, and respective prior delivery timing information for each of the one or more prior delivery requests.

14. The method in claim 13, wherein:
the driver assignment process for the delivery request further comprises:
a pre-surge assignment process; and
a broadcast surge assignment process; and
each of the one or more prior accepted delivery requests for training the base price machine learning model is accepted in the pre-surge assignment process.

15. The method in claim 11, wherein:
determining the elasticity coefficient for the desirability score further comprises determining, by an elasticity machine learning model, the elasticity coefficient for the desirability score;
the elasticity machine learning model is pre-trained to determine the elasticity coefficient for the desirability score based on:
third historical input feature vectors for one or more prior accepted delivery requests; and
third historical output data comprising a respective prior accepted price for each of the one or more prior accepted delivery requests; and
each of the third historical input feature vectors is associated with a respective historical dataset comprising a respective prior desirability score, a respective prior source location, a respective prior order size group, a respective prior delivery distance, and respective prior delivery timing information for each of the one or more prior accepted delivery requests.

16. The method in claim 15, wherein:
the driver assignment process for the delivery request further comprises:
a pre-surge assignment process; and
a broadcast surge assignment process; and
each of the one or more prior accepted delivery requests for training the elasticity machine learning model is accepted in the pre-surge assignment process or the broadcast surge assignment process.

17. The method in claim 11, wherein:
the driver assignment process for the delivery request further comprises:
a pre-surge assignment process; and
a broadcast surge assignment process.

18. The method in claim 17, wherein:
the desirability machine learning model is pre-trained based on a training dataset associated with one or more prior delivery requests; and
the training dataset further comprises a respective desirability indication of whether each of the one or more prior delivery requests is accepted at the pre-surge assignment process.

19. The method in claim 17, wherein:
the driver assignment process further comprises an external driver assignment process; and
implementing the driver assignment process for the delivery request further comprises:
implementing the pre-surge assignment process for the delivery request;
after implementing the pre-surge assignment process, implementing the broadcast surge assignment process; and
after implementing the broadcast surge assignment process, implementing the external driver assignment process.

20. The method in claim 19, wherein:
implementing the pre-surge assignment process for the delivery request further comprises:
implementing a round-robin assignment process; and
after implementing the round-robin assignment process, implementing a broadcast assignment process until a predetermined broadcast time period passes before the delivery request is accepted.
